(19) United States
(12) Patent Application Publication
(10) Pub. No.: US 2004/0207626 A1
(43) Pub. Date: Oct. 21, 2004

(54) Method for filling a closed region

(76) Inventor: Han-Zhou Li, SuZhou City (CN)

Correspondence Address: RABIN & Berdo, PC, 1101 14TH STREET, NW, SUITE 500, WASHINGTON, DC, 20005, US

(21) Appl. No.: 10/825,235

(22) Filed: Apr. 16, 2004

(30) Foreign Application Priority Data
Apr. 17, 2003 (TW) 92108993

(51) Int. Cl. G06T 11/20

(52) U.S. Cl. 345/441

(57) ABSTRACT

A method for filling a closed region. The closed region is enclosed by a contour according to a plurality of edge points. First, generate a path linked list. The path linked list includes a plurality of nodes for recording the edge points and the intermediate points between the edge points on the contour. Next, generate a filling array linked list. The filling array linked list records a plurality of filling line segment. The two end points of each of the line segments are on the contour, and each of the line segments is in the closed region. Then, fill the closed region according to the line segments.

This application claims the benefit of Taiwan application Serial No. 092108993, filed Apr. 17, 2003, the subject matter of which is incorporated herein by reference.

### BACKGROUND OF THE INVENTION

1. Field of the Invention

The invention relates in general to a method for filling a closed region, and more particularly to a quick method for filling a closed region.

2. Description of the Related Art

Please refer to FIG. 1, a flowchart for a conventional method for filling a closed region. First, obtain the coordinates for edge points on the paths as shown in step 110, wherein these edge points are exemplified in FIG. 2. Next, obtain the smallest rectangle which contains all edge points as shown in step 120. After that, create a region in the memory wherein the region corresponds to the smallest rectangle containing all edge points (one byte corresponds to one pixel) as shown in step 130. Following that, label all of the points outside the closed region, all of the points inside the closed region, and all of the edge points, slanting line segments (including vertical segments but excluding edge points) and horizontal segments (excluding edge points) on the path with different values in the memory region as shown in step 140. After that, proceed scanning point by point to check if these points are edge points of a filling segment according to their present positions and labeled values as shown in step 150. Last, fill this enclosed region according to the values of the filling segments obtained above as shown in step 160.

Taking a contour consists of 100 edge points for example. These edge points are distributed in a region of 100 pixels by 100 pixels. To check if a point is within the contour in the third step of the old algorithm, the coordinates of this point (100×100 points totally) need to be compared against the coordinates of all edge points on the path (100 points totally). This step alone takes a million times of operation (100×100×100) which will consume a large amount of CPU time. When determining whether a particular point is an edge point of a filling segment, these 100×100 points need to be checked individually which will consume an even larger number of operations.

In step 130, a region of 100 bytes by 100 bytes corresponding to the region of 100 by 100 pixels where the edge point is distributed needs to be created in the memory. When the region of the distribution of the edge point is large, huge memory space will be occupied.

### SUMMARY OF THE INVENTION

It is therefore an object of the invention to provide a quick method for filling a closed region.

According to the object of the invention, a method for filling a closed region is provided wherein the closed region is enclosed by a contour formed by a plurality of edge points. The method includes the following steps. First, generate a path linked list which includes a plurality of nodes for recording the edge points and their intermediate points on the contour. Next, generate a filling array linked list according to the path linked list for recording a plurality of filling line segments wherein the two end points of each filling line segment are located on the contour and these filling line segments are located within the closed region. Last, fill the closed region according to these filling line segments.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a flowchart for a conventional method for filling a closed region;

FIG. 2 is a diagram illustrating the distribution of plural edge points on a plane;

FIG. 3 is a flowchart for a method for filling a closed region according to a preferred embodiment of the invention;

FIG. 4A is a flowchart for determining the line flag for an edge point;

FIG. 4B is a flowchart for determining the point flag for an edge point;

FIG. 4C is a method flowchart for determining the end point flag for an edge point;

FIGS. 4D and 4E are method flowcharts for generating a path linked list;

FIG. 5A is a schematic diagram for the pixels linked to path linked list P;

FIG. 5B is the content of path linked list P;

FIGS. 6A and 6B are method flowcharts for generating a filling array linked list;

FIG. 7 is the content of a filling array linked list generated according to the processes illustrated in FIGS. 6A and 6B;

FIG. 8 is a schematic diagram for a filled closed region.

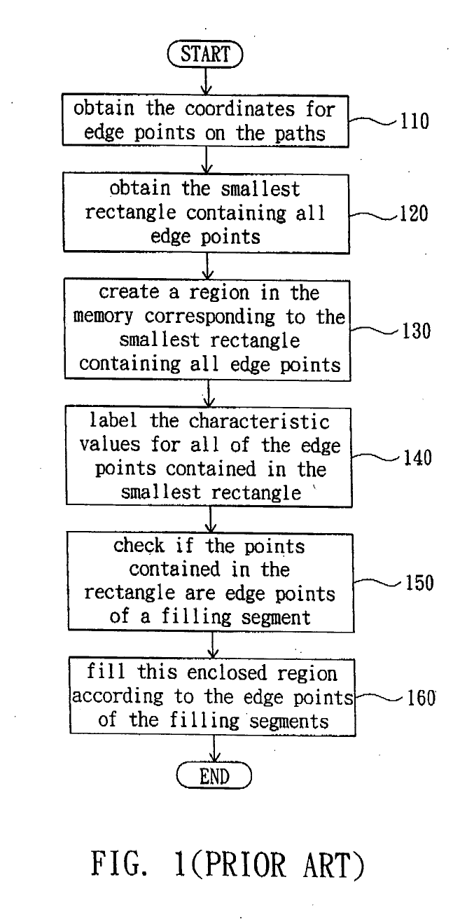

### DETAILED DESCRIPTION OF THE INVENTION

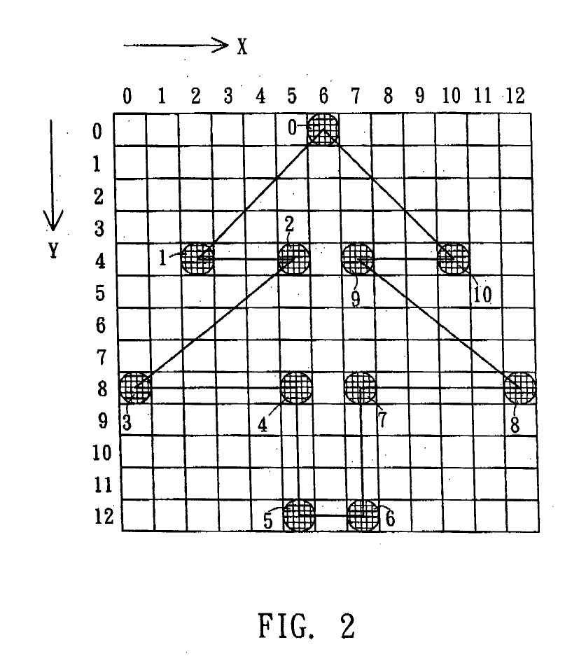

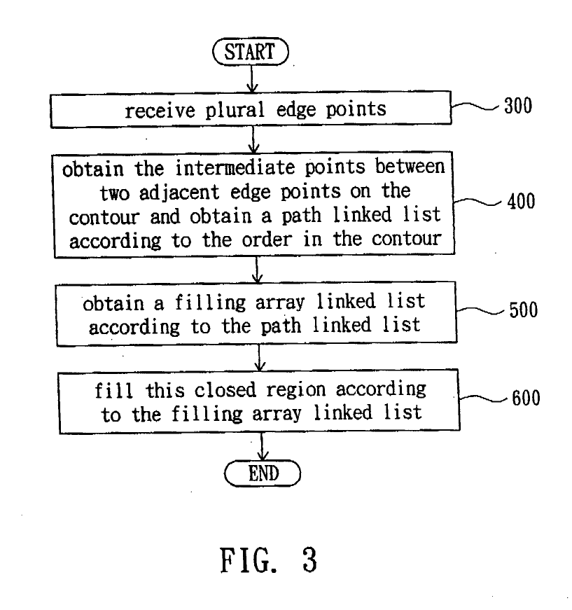

Please refer to FIG. 2, a diagram illustrating the distribution of plural edge points on a plane. The coordinates for edge point (0) to edge point (10) are (6,0), (2,4), (5,4), (0,8), (5,8), (5,12), (7,12), (7,8), (12,8), (7,4) and (10,4) respectively, while the last edge point, edge point (11), is also edge point (0). These edge points form a contour with a closed region enclosed within. The following disclosures use these edge points as examples. FIG. 3 is a flowchart for a method for filling a closed region according to a preferred embodiment of the invention. First, receive these edge points as shown in step 300 then record the coordinates of these edge points into a egde-point array, orderly by their position on the contour, wherein the last edge point on the path is also the first edge point on the path. Next, obtain all the intermediate points between edge points on the contour and store these edge points and their intermediate points in path linked list P following their order on the contour as shown in step 400. After that, obtain a filling array linked list G according to path linked list P as shown in step 500 wherein filling array linked list G records the two edge points of the horizontal line segment to be filled. Last, fill this closed region according to filling array linked list G as shown in step 600.

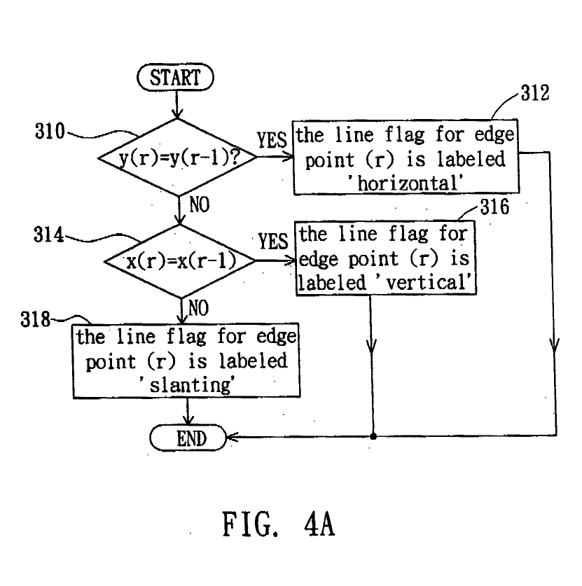

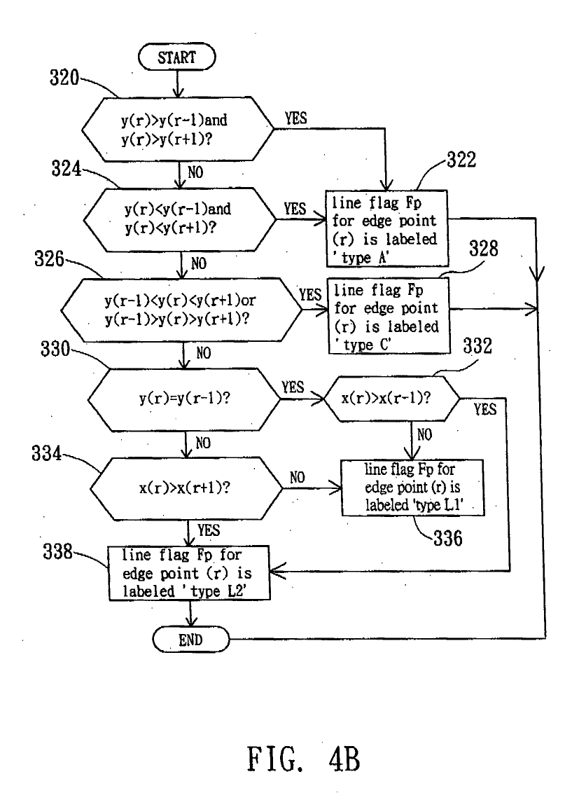

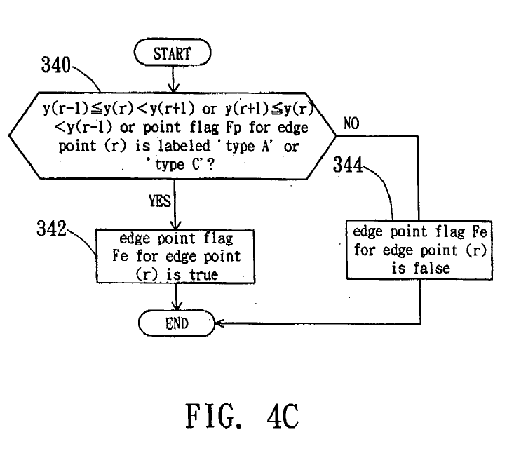

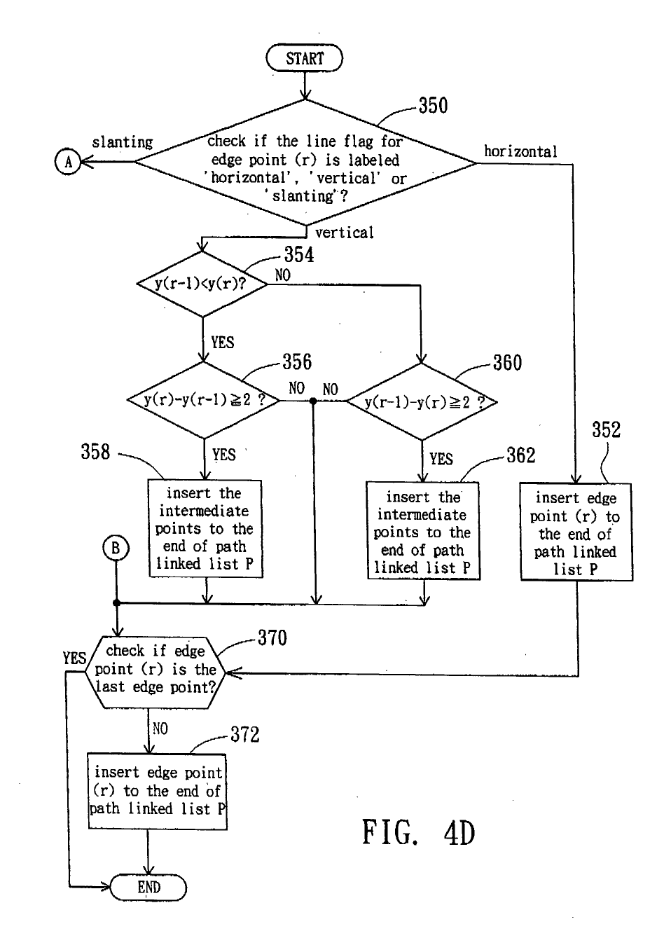

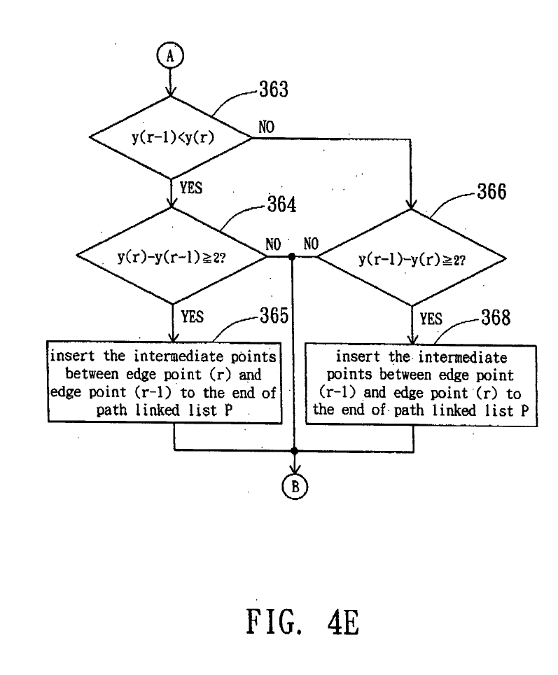

The method for generating path linked list P in step 400 is further elaborated below. First, determine the attributes of each edge point as shown in flowcharts FIG. 4A to 4C. Next, calculate all the intermediate points between every two adjacent edge points on the contour and store these edge points and their intermediate points in path linked list P following their order on the contour as shown in flowcharts FIG. 4D to 4E.

Each edge point has a horizontal coordinate x and a vertical coordinate y, and possesses different attributes according its relative positions with other edge points. Let Fl represent the line flag; Fp: the point flag; and Fe: the end point flag. Let edge point (r) represent present edge point; edge point (r−1): previous edge point; and edge point (r+1): next edge point. If edge point (r) is the first edge point, i.e., edge point (0), then edge point (r−1) will be edge point (10). By the same token, if edge point (r) is edge point (11), then edge point (r+1) will be edge point (1) wherein r is a positive integer.

Please refer to FIG. 4A, a flowchart for determining the line flag for an edge point. Line flag Fl is labeled ‘vertical’, ‘horizontal’ or ‘slanting’ according to the line segment formed by present edge point and its previous edge point. First, check if y(r), the vertical coordinate of present edge point (r), equals y(r−1), the vertical coordinate of previous edge point (r−1), as shown in step 310. If y(r) equals y(r−1), then a horizontal line segment formed by edge point (r) and edge point (r−1) is implied. Label line flag Fl for present edge point (r), say, edge point (2) for instance, ‘horizontal’ as shown in step 312. If y(r) is not equal to y(r−1), check if x(r), the horizontal coordinate of present edge point (r), equals x(r−1), the horizontal coordinate of previous edge point (r−1), as shown in step 314. If x(r) equals x(r−1), label line flag Fl for present edge point (r), say, edge point (5) for instance, ‘vertical’ as shown in step 316. Otherwise, neither the horizontal nor the vertical coordinates of edge point (r) is equal to that of edge point (r−1). Label line flag Fl for edge point (r), say, edge point (1) for instance, ‘slanting’ as shown in step 318.

Please refer to FIG. 4B, a flowchart for determining the point flag for an edge point. Point flag Fp is labeled ‘type A’, ‘type C’, ‘type L1’ or ‘type L2’ according to the position of present edge point (r) and its relative positions with previous edge point (r−1) and next edge point (r+1). First, check if y(r), the vertical coordinate of present edge point (r), is greater than both y(r−1) and y(r+1), the vertical coordinate of previous edge point (r−1) and the vertical coordinate of next edge point (r+1) respectively, as shown in step 320. If yes, label point flag Fp for edge point (r), say, edge point (0) for instance, ‘type A’; otherwise, check if y(r) is smaller than both y(r−1) and y(r+1) as shown in step 324. If yes, label point flag Fp for edge point (r) ‘type A’ as shown in step 322; otherwise, check if y(r) is between y(r−1) and y(r+1) as shown in step 326. If yes, label point flag Fp for edge point (r) ‘type C’ as shown in step 328; otherwise, y(r) equals either y(r−1) or y(r+1). Now, check if y(r) equals y(r−1) as shown in step 330, i.e., present edge point (r) and previous edge point (r−1) share the same vertical coordinate. If this is the case, the line segment between edge point (r) and edge point (r−1) is horizontal, go to step 332; otherwise, the line segment between edge point (r) and edge point (r+1) is horizontal, go to step 334. Further check if x(r), the horizontal coordinate of present edge point (r) is greater than the horizontal coordinate of previous edge point (r−1) in step 332. If yes, label point flag Fp for edge point (r), say, edge point (2) for instance, ‘type L2’ as shown in step 338; otherwise, label point flag Fp for edge point (r) ‘type L1’ as shown in step 336. Further check if x(r), the horizontal coordinate of present edge point (r) is greater than the horizontal coordinate of next edge point (r+1) in step 334. If yes, label point flag Fp for edge point (r) ‘type L2’ as shown in step 338; otherwise, label point flag Fp for edge point (r) ‘type L1’ as shown in step 336.

Please refer to FIG. 4C, a flowchart for determining the end point flag for an edge point. Check the three conditions in step 340, if any of the three conditions is satisfied, the end point flag Fe for edge point (r) is true (step 342), otherwise, the end point flag Fe for edge point (r) is false (step 344). The first condition is satisfied when y(r) is smaller than y(r+1) but is greater than or equal to y(r−1). The second condition is satisfied when y(r) is smaller than y(r−1) but is greater than or equal to y(r+1). The third condition is satisfied when point flag Fp for edge point (r) is ‘type A’ or ‘type C’. If end point flag Fe is true, then edge point (r) is an end point of a filling line segment. Repeat the flowcharts illustrated in FIG. 4A to 4C until all the edge points have obtained their line flag Fl, point flag Fp and end point flag Fe.

Next, calculate all the intermediate points between every two adjacent edge points on the contour and store these edge points and their intermediate points in path linked list P following their order in the contour. FIGS. 4D and 4E are flowcharts for generating the path linked list. The step for generating the path linked list according to line flag Fl includes the step of obtaining intermediate points and the step of inserting the edge points and the immediate points orderly. Step 350 checks the label of line flag Fl. If line flag Fl is labeled ‘horizontal’, perform step 352; if line flag Fl is labeled ‘vertical’, perform step 354; if line flag Fl is label ‘slanting’,perform step 363

If line flag Fl for edge point (r) is labeled ‘horizontal’, then insert edge point (r) into the end of path linked list P (step 352) and perform step 370 to check if edge point (r) has been inserted into path linked list P. That is to say, if the line segment between edge point (r) and edge point (r−1) is horizontal, then their intermediate points will not be recorded in path linked list P.

If line flag Fl for edge point (r) is labeled ‘vertical’, go to step 354 to check if y(r) is greater than y(r−1); if yes, further checks if the difference between y(r) and y(r−1) is greater than or equal to 2. If yes, there are intermediate points between edge point (r) and edge point (r−1), and insert these intermediate points into path linked list P in the ascending order of vertical coordinates (step 358); otherwise, go to step 360. Step 360 checks if the difference between y(r) and y(r−1) is greater than or equal to 2. If yes, there are intermediate points between edge point (r) and edge point (r−1) and insert these intermediate points into path linked list P in the descending order of vertical coordinates (step 358); otherwise, go to step 370.

If line flag Fl for edge point (r) is labeled ‘slanting’, step 363 is performed to check if y(r) is greater than y(r−1); if yes, further check if the difference between y(r) and y(r−1) is greater than or equal to 2. If yes, there are intermediate points between edge point (r) and edge point (r−1) and insert these intermediate points into path linked list P in the ascending order of vertical coordinates (step 364); otherwise, go to step 366. Step 366 checks if y(r) is smaller than y(r−1); if yes, further check if the difference between y(r) and y(r−1) is greater than or equal to 2. If yes, there are intermediate points between edge point (r) and edge point (r−1) and insert these intermediate points into path linked list P in the descending order of vertical coordinates (step 368); otherwise, go to step 370. The above intermediate points are obtained according to a line equation formed by edge point (r) and edge point (r−1). In step 370, if edge point (r) is not the last edge point on the path, insert edge point (r) to the end of path linked list P. Repeat the method illustrated in FIG. 4d and 4E until all the edge points and intermediate points have been stored into path linked list P according to their order in the contour.

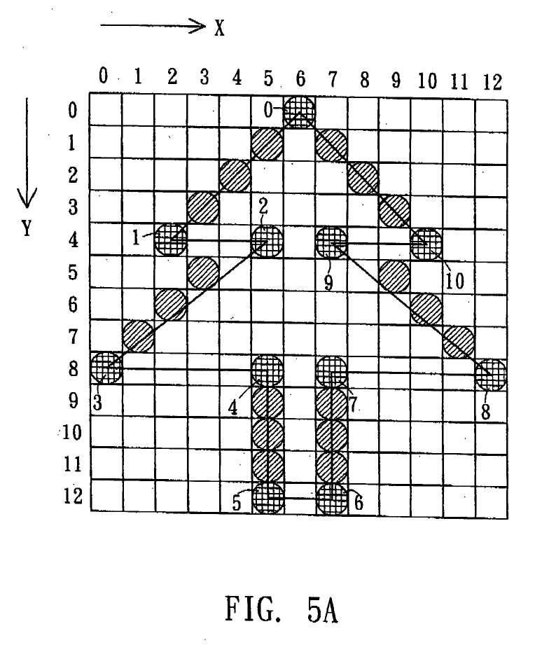

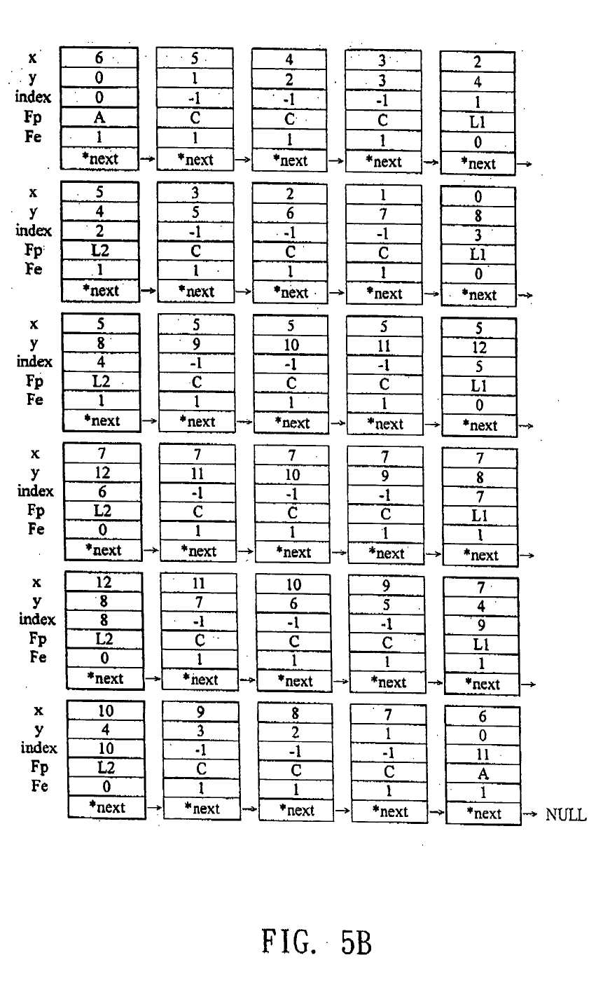

FIG. 5A is a schematic diagram for the pixels linked to path linked list P. Apart from edge points, the intermediate points between two adjacent edge points are obtained as well, but no intermediate point between the two edge points of a horizontal line segment is necessary to be recorded. For example, no intermediate point between edge point (1) and edge point (2) is recorded. FIG. 5B is the content of path linked list P. Each element in path linked list P corresponds to an edge point or an intermediate point wherein each element includes the horizontal coordinate x, the vertical coordinate y, an index, the point flag Fp, an end point flag Fe and a pointer ‘next’. Index is used to record the order of each edge point while the value of index for each intermediate point is −1. For example, the value of index for edge point (0) is 0. The point flag for each intermediate point is labeled ‘type C’. When end point flag Fe is true, its value in path linked list P is 1; when Fe is false, its value in path linked list P is 0. Pointer ‘next’ directs toward next node. Each element is linked according to their order in the contour.

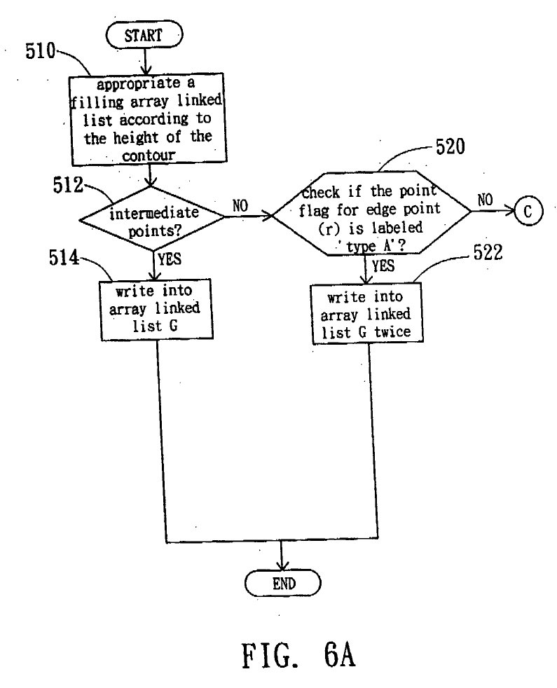

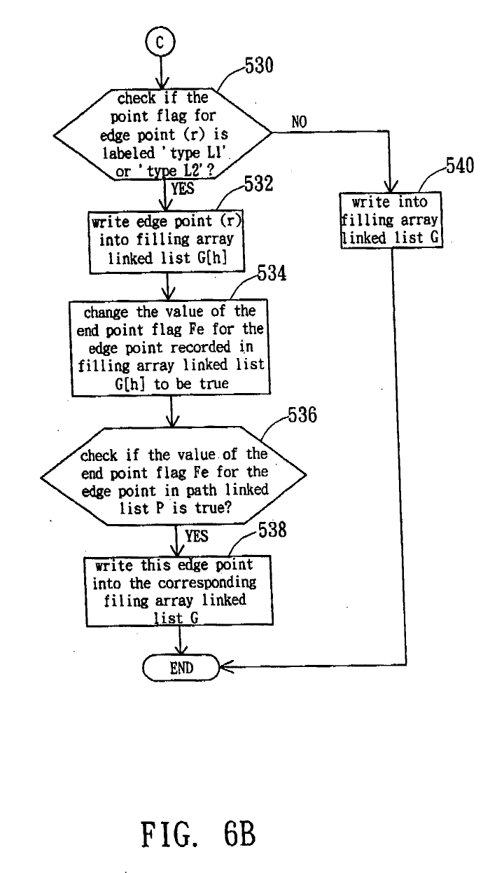

The details for step 500, generating a filling array linked list shown in FIG. 3, are further elaborated below. First, appropriate a filling array linked list G according to the height of the contour, h. In present embodiment, the value of h is 13. Each array in filling array linked list G corresponds to a linked list wherein a linked list corresponds to the pixels in the same row. For example, array G[0] corresponds to the pixels whose vertical coordinates are 0 (y=0); array G[1] corresponds to the pixels whose vertical coordinates are 1 (y=1); . . . ; array G[12] corresponds to the pixels whose vertical coordinates are 12 (y=12). Moreover, the linked list corresponding to array G[13] records all of the horizontal lines in the contour. Each linked list that each G[ ] corresponds to includes the two end points of a filling line segment. The closed region enclosed by these edge points can be filled according to these filling line segments. FIGS. 6A and 6B are flowcharts for generating a filling array linked list whereby all edge points and intermediate points, i.e., the nodes in path linked list P, are sequentially written into filling array linked list G. First, check if a node is an intermediate point (step 512). If yes, write this node into its corresponding filling array linked list G[y] according to its vertical coordinate y (step 514); otherwise, this node is an edge point. Step 520 checks if point flag Fp for an edge point is type A. If yes, write the edge point into its corresponding filling array linked list G[y] twice according to its vertical coordinate y. The reason for writing the edge point twice is: an A-typed point flag Fp implies that there is only one point on the horizontal line, e.g., edge point A in FIG. 2, so writing the edge point twice implies that the start point and the end point of this filling line segment is the same point. Next, check if point flag Fp for edge point (r) is type L1 or type L2 (step 530). If yes, this edge point (r) is on a horizontal line segment in the contour, go to step 532; otherwise, go to step 540. The edge point (r) is written into filling array linked list G[h] in step 532. Next, change the value of end point flag Fe of the edge point in filling array linked list G[h] to be true in step 534. After that, check if end point flag Fe for the edge point in path linked list P is true in step 536. If yes, write the edge point into its corresponding filling array linked list G[y] according to its vertical coordinate y (step 538). If point flag Fp for an edge point is type C, write this edge point into its corresponding filling array linked list G[y] according to vertical coordinate y of this edge point (step 540).

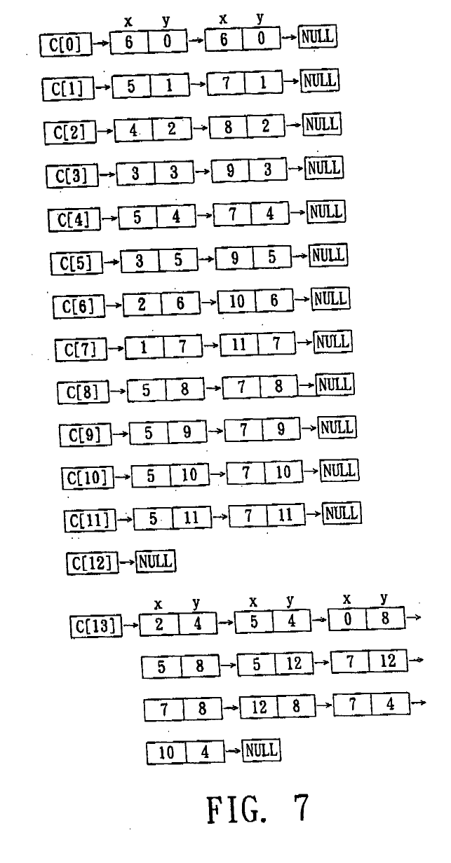

FIG. 7 is the content of a filling array linked list generated according to the process illustrated in FIGS. 6A and 6B. Filling array linked list G[0] corresponds to filling line segment (6,0)(6,0) whose vertical coordinates equal 0 (y=0); filling array linked list G[1] corresponds to filling line segment (5,1)(7,1) whose vertical coordinates equal 1 (y=1); filling array linked list G[2] corresponds to filling line segment (4,2)(8,2) whose vertical coordinates equal 2 (y=2); filling array linked list G[3] corresponds to filling line segment (3,3) (9,3) whose vertical coordinates equal 3 (y=3); . . . ; filling array linked list G[11] corresponds to filling line segment (5,11) (7,11) whose vertical coordinates equal 0 (y=0). Filling array linked list G[12] corresponds to a filling line segment whose vertical coordinates equal 12 (y=12) wherein no such filling line segment exists. Filling array linked list G[h], i.e., G[13], is a horizontal linked list for recording all the horizontal line segments (2,4) (5,4), (0,8) (5,8), (5,12)(7,12), (7,8)(12,8) and (7,4)(10,4) in the contour.

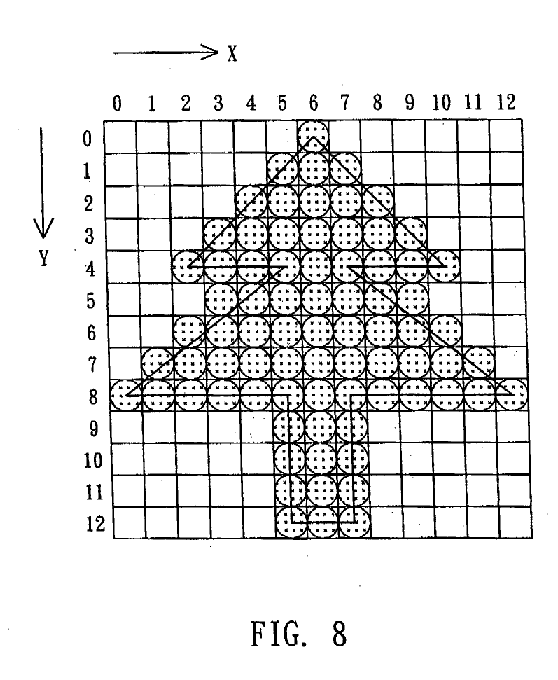

Last, fill the closed region according to filling array linked list G. Please refer to FIG. 8, a schematic diagram for a filled closed region. The coordinates for the end points of a filling line segment can be obtained according to filling array linked list G. The filling of the closed region will be completed after having linked the edge points of each filling line segment using specific colors and having colored all the filling line segments and the horizontal line segments in the contour.

The method for filling a closed region according to the above disclosed preferred embodiment has the following advantages:

1. Reducing the number of operations:

a. Unlike the conventional method which compares all of the pixels in the closed region, the present method compares only the pixels on the contour, hence reducing the number of operation.

b. Only simple numeric comparisons are needed: no complicated multiplication or division is involved, hence reducing the number of operation.

2. Reducing memory requirement:

Conventional method requires a memory region corresponding to all the pixels in the smallest rectangle which contains all edge points, therefore a large memory space is required. The present method only needs path linked lists, filling array linked lists etc., so the memory space occupied is smaller.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for filling a closed region, wherein the closed region is enclosed by a contour formed by a plurality of edge points, and each of the edge points has a previous edge point and a next edge point according to its order in the contour, the method comprising:
generating a path linked list comprising a plurality of nodes for recording the edge points on the contour and a plurality of intermediate points between the edge points on the contour;
generating a filling array linked list according to the path linked list for recording a plurality of filling line segments, wherein the two end points of each filling line segment are located on the contour while these filling line segments are located within the closed region; and
filling the closed region according to these filling line segments.

2. The filling method according to claim 1, wherein step of generating the path linked list comprises the steps of:
a1. determining a line flag of the edge point according to the relative position between the edge point and the previous edge point, wherein the line flag is of a first value if the line formed by the edge point and the previous edge is horizontal, of a second value if the line is vertival, and of a third value if the line is slanted;
a2. inserting the intermediate point into the path linked list if the intermediate point exists between the edge point and the previous edge point; and
a3. inserting the edge point to the end of the path linked list if the edge point is not the last edge point on the contour.

3. The filling method according to claim 2, wherein, in step a2 of the method, the intermediate point between the edge point and the previous edge point is not inserted if the line flag of the edge point is of the first value.

4. The filling method according to claim 2, wherein, in step a2, the intermediate points between the edge point and the previous edge point are inserted to the end of the path linked list in ascending order of vertical coordinates if the line flag of the edge point is of the second value and that the vertical coordinate of the edge point is greater than that of the previous edge point.

5. The filling method according to claim 2, wherein, in step a2, the intermediate points between the edge point and the previous edge point are inserted to the end of the path linked list in descending order of vertical coordinates if the line flag of the edge point is of a second value and that the vertical coordinate of the edge point is smaller than that of the previous edge point and that intermediate points exist between the edge point and the previous edge point.

6. The filling method according to claim 2, wherein, in step a2 of the method, the intermediate points between the edge point and the previous edge point are inserted to the end of the path linked list in ascending order of vertical coordinates if the line flag of the edge point is labeled ‘slanting’ and that the vertical coordinate of the edge point is greater than that of the previous edge point.

7. The filling method according to claim 2, wherein, in step a2, the intermediate points between the edge point and the previous edge point are inserted to the end of the path linked list in descending order of vertical coordinates if the line flag of the edge point is of a third value and that the vertical coordinate of the edge point is smaller than that of the previous edge point.

8. The filling method according to claim 7, wherein, in step a2, the intermediate points are obtained from a linear equation formed by the edge point and the previous edge point.

9. The filling method according to claim 2, wherein, in step a1, the line flag of the edge point is of the first value if the horizontal coordinate of the edge point is equal to that of the previous edge point.

10. The filling method according to claim 2, wherein, in step a1 of the method, the line flag of the edge point is of the second value if the vertical coordinate of the edge point is equal to that of the previous edge point.

11. The filling method according to claim 2, wherein, in step a1 of the method, the line flag of the edge point is of the third value if neither the horizontal coordinate nor the vertical coordinate of the edge point is equal to that of the previous edge point.

12. The filling method according to claim 1, wherein the filling array linked list has a plurality of line segment linked lists wherein each of these line segment linked lists is used for recording one of these filling line segments.

13. The filling method according to claim 12, wherein these filling line segments are horizontal.

14. The filling method according to claim 13, wherein, in the step of generating the filling array linked list, the intermediate point in the path linked list is recorded into its corresponding line segment linked list according to the vertical coordinate of the intermediate point.

15. The filling method according to claim 13, wherein, in the step of generating the filling array linked list, the edge point in the path linked list is recorded into its corresponding line segment linked list twice according to the vertical coordinate of the edge point if the vertical coordinate of the edge point is greater than that of both the previous edge point and the next edge point.

16. The filling method according to claim 13, wherein, in the step of generating the filling array linked list, the edge point in the path linked list is recorded into its corresponding line segment linked list twice according to the vertical coordinate of the edge point if the vertical coordinate of the edge point is smaller than that of both the previous edge point and the next edge point.

17. The filling method according to claim 13, wherein the filling array linked list further comprises a horizontal linked list for recording at least one horizontal line segment on the contour.

18. The filling method according to claim 17, wherein, in the step of generating the filling array linked list, the edge point in the path linked list is recorded into the horizontal linked list of the filling array linked list if the edge point forms the horizontal line segment together with either the previous edge point or the next edge point.

19. The filling method according to claim 17, wherein, in the step of generating the filling array linked list, the edge point in the path linked list is recorded into its corresponding horizontal linked list according to its vertical coordinate if the edge point forms the horizontal line segment together with the previous edge point.

20. The filling method according to claim 13, wherein, in the step of generating the filling array linked list, the edge point in the path linked list is recorded into its corresponding horizontal linked list according to its vertical coordinate if the vertical coordinate of the edge point lies between the vertical coordinate of the previous edge point and the vertical coordinate of the next edge point.

21. The filling method according to claim 13, wherein, in the step of filling the closed region, the filling line segments recorded in the line segment linked lists are filled individually.

22. The filling method according to claim 17, wherein, in the step of filling the closed region, the filling line segments recorded in the line segment linked lists and the horizontal line segment in the horizontal linked list are filled individually.
